(19) United States
(12) Patent Application Publication
(10) Pub. No.: US 2005/0097019 A1
(43) Pub. Date: May 5, 2005

(54) Method and system for validating financial instruments

(76) Inventor: Ronald F. Jacobs, Napa, CA (US)

Correspondence Address: MICHAEL BEST & FRIEDRICH, LLP, 100 E WISCONSIN AVENUE, MILWAUKEE, WI, 53202, US

(21) Appl. No.: 10/701,382

(22) Filed: Nov. 4, 2003

(51) Int. Cl. G06F 17/60

(52) U.S. Cl. 705/35; 705/45

(57) ABSTRACT

Some embodiments of the present application call for a method of validating a financial instrument having a first data field and a second data field, in which the method comprises establishing criteria triggering a confidence threshold increase for the first data field of the financial instrument, the criteria accessible by a processor adapted to compare data from fields of the financial instrument to the criteria; obtaining a second data record from the second data field of the financial document; comparing the second data record to the criteria with the processor; and automatically modifying the confidence threshold of the first data field of the financial instrument if the criteria are met by the second data.

### BACKGROUND OF THE INVENTION

This invention relates to validating instruments, and, relates in some embodiments to validating financial instruments.

### SUMMARY OF THE INVENTION

Some embodiments of the present invention provide a method of validating a financial instrument relating to a financial transaction, wherein method comprises obtaining data defining a first part of the financial transaction; obtaining data defining a second part of the financial transaction; comparing the data defining the first part of the financial transaction with a value in a first field of the financial instrument to define a first comparison and to generate a first confidence value, the first confidence value at least partially defining a degree of difference between the data defining the first part of the financial transaction and the value in the first field of the financial instrument; comparing the data defining the second part of the financial transaction with a value in a second field of the financial instrument to define a second comparison and to generate a second confidence value, the second confidence value at least partially defining a degree of difference between the data defining the second part of the financial transaction and the value in the second field of the financial instrument; providing first and second ranges of acceptable confidence values for the first and second comparisons, respectively; comparing the first confidence value to the first range of acceptable confidence values, the first range of acceptable confidence values including a range of low confidence values; and altering the second range of acceptable confidence values if the first confidence value falls within the range of low confidence values.

In another aspect of the present invention, a method of validating a financial document is provided, and includes obtaining a digital representation of the financial document, the financial document having a first data field and a second data field; obtaining a first data record from the first data field of the financial document; establishing a first validation threshold corresponding to the first data field; obtaining a second data record from the second data field of the financial document; establishing a second validation threshold corresponding to the second data field; retrieving a first model record corresponding to the first data record; comparing the first data record to the first model record; generating a first confidence value corresponding to the comparison of the first data record to the first model record, the first confidence value reflecting a degree of similarity between the first data record and the first model record; modifying the second validation threshold if the first confidence value is within a predefined range of low confidence values to produce a modified second validation threshold; retrieving a second model record corresponding to the second data record; comparing the second data record to the second model record; producing a second confidence value corresponding to the comparison of the second data record to the second model record, the second confidence value reflecting a degree of similarity between the second data record and the second model record; and comparing the second confidence value to the modified second validation threshold.

Some embodiments of the present invention provide a method of automatically financial instruments, wherein the method comprises obtaining a first digital representation of a first financial instrument having a first field; obtaining a second digital representation of a second financial instrument having a second field, the second field representing substantially the same type of information as the first field; establishing a first validation threshold for the first field and a second validation threshold for the second field, the second validation threshold being substantially the same as the first validation threshold; comparing data in the first field to corresponding first model data to produce a first confidence level of the data in the first field; validating the first financial document and leaving the second financial threshold unchanged if the first confidence level exceeds the first validation threshold; modifying the second validation threshold if the first confidence level does not exceed the first validation threshold but exceeds a low-confidence validation threshold of the first field to produce a modified second validation threshold, the low-confidence validation threshold of the first field different than the first validation threshold; comparing data in the second field to corresponding second model data to produce a second confidence level of the data in the second field; and validating the second document if the second confidence level exceeds the modified second validation threshold.

In yet another aspect of the present invention, a method of validating a financial instrument having a first data field and a second data field is provided, and calls for establishing criteria triggering a confidence threshold increase for the first data field of the financial instrument, the criteria accessible by a processor adapted to compare data from fields of the financial instrument to the criteria; obtaining a second data record from the second data field of the financial document; comparing the second data record to the criteria with the processor; and automatically modifying the confidence threshold of the first data field of the financial instrument if the criteria are met by the second data.

Further objects of the present invention together with the organization and manner of operation thereof, will become apparent from the following detailed description of the invention when taken in conjunction with the accompanying drawings wherein like elements have like numerals throughout the drawings.

### BRIEF DESCRIPTION OF THE DRAWINGS

The present invention is further described with reference to the accompanying drawings, which show exemplary embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

FIG. 1 is a schematic diagram of a financial instrument validation system according to an exemplary embodiment of the present invention.

FIG. 2 is schematic diagram of another embodiment of the financial instrument validation system of FIG. 1.

FIG. 3 is a schematic diagram of a financial transaction to be validated by the system of FIG. 1.

FIG. 4 is a flowchart illustrating a method of validating the financial transaction illustrated in FIG. 3.

### DETAILED DESCRIPTION

The present invention is not limited in its application to the details set forth in the following description or illustrated in the following drawings. The invention is capable of other embodiments and of being practiced or of being carried out in various ways. Also, the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “connected” and “coupled” are used broadly and encompass both direct and indirect connections and couplings. In addition, the terms “connected” and “coupled” are not restricted to physical or mechanical connections or couplings. As used herein the terms “machine,” “computer,” “server,” and “work station” are not limited to a device with a single processor, but may encompass multiple devices (e.g., computers) linked in a system, devices with multiple processors, special purpose devices, devices with various peripherals and input and output devices, software acting as a computer or server, and combinations of the above.

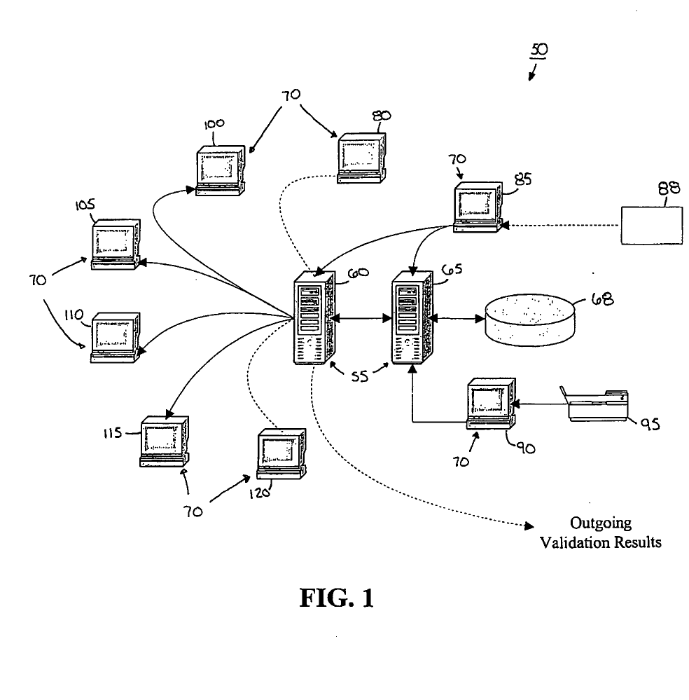

FIG. 1 illustrates a financial instrument validation system 50 according to an exemplary embodiment of the present invention. In some embodiments, the system 50 can validate an instrument of any financial transaction, including, for example, but not limited to, checks, receipts, account deposit documents, account withdrawal documents, account transfer documents, collection documents, promissory notes, letters of credit, bonds, stock certificates, cash and other currency, any of which can be in paper or electronic form (e.g., an electronic or paper document reflecting a funds transfer between bank accounts, paper or digital cash, a personal check or electronic image of such a check, and the like) and can be in any format (e.g., summary, table, field-based form, and the like). In other embodiments, the system 50 is used to validate instruments of other transactions, including without limitation wills, asset licenses, assignments, contracts, and other legal instruments, any of which can be in paper or electronic form and can be in any format as just described. As used herein and in the appended claims, the term “instrument” is employed to refer to any and all such items, while the term “financial instrument” is employed to refer only to those items of a financial transaction.

It should be noted that the system 50 can validate any part or all of an instrument (in a financial transaction or otherwise), such as validation of less than all parts of a completed bank check. In other embodiments of the present invention, the system 50 can validate part or all of other paper or electronic items, documents, and/or transactions including, for example, but not limited to, facsimiles, files, identification cards, correspondence, information transferred or exchanged via a network, photographs, video, and other images, any of which can be in paper or electronic form. As used herein and in the appended claims, such items also fall within the term “instrument”.

Although the system 50 according to the present invention can be employed to validate any instrument, it will be appreciated by those skilled in the art that the process of validating some types of instruments involve issues unique to those type of instruments. This is the case in the process of validating financial instruments, where financial regulations, security factors, processing speeds, and the frequent need to rapidly execute multiple unrelated procedures (e.g., credit and debit accounts, route and store records reflecting the transaction to different locations, and perform verifications checks of the transaction) present challenges unique to the design of financial instrument validation systems. The following description refers to financial instruments and a system 50 adapted to validate such instruments. However, this description is presented by way of example only. Although the system 50 is particularly useful for validating financial instruments and provides special advantages in validating financial instruments, the present invention can be employed to validate any instrument in any type of transaction as described above.

In some embodiments of the present invention, the system 50 processes financial instruments by identifying and reading the data in one or more fields of the financial instrument and comparing that data to model data accessible by the system 50. These fields can contain information in any form, including without limitation numbers, letters, symbols, graphics, holograms, machine-readable elements, combinations of such information, and the like. The data in these fields can correspond to data representative of any information relevant to a financial transaction, including without limitation names (both personal and organizational), dollar amounts, dates, signatures, descriptions, addresses, account numbers, routing numbers, combinations of such information, and the like. Many different systems and methods exist for identifying and reading the information in fields of financial instruments as described above—any of which can be employed in connection with the system 50 of the present invention.

Another aspect of financial instrument validation involves the validation of the data read from a field of the financial instrument. This process often involves an automated or semi-automated system adapted to read the data from the field (in whatever form that data is in), to “recognize” the data, and to compare the data to known or “model” data in order to determine the degree of similarity or difference between the read and recognized data and the model data. The process of recognizing the data can be performed by a number of different system, such as a character recognition system adapted to recognize letters, numbers, and other symbols. As another example, this system can instead or also recognize graphics (such as a handwriting recognition system). Still other data recognition systems exist, each one of which can be employed in connection with the present invention.

The process of comparing the data from the field to the model data typically results in a “confidence value” generated by the system reflecting the similarity or difference between this data. This confidence value can be a number, a name or other alphanumeric designation, a symbol, a graphical depiction, a color, or can take any other form, and can be compared to one or more acceptable confidence levels in order to determine whether the data read from the field matches the model data.

The confidence value of data read, recognized, and compared as just described can be compared to one or more acceptable confidence values defined in larger range of acceptable and unacceptable confidence values (typically separated by a “threshold” confidence value above which the data read from the field is considered to match the model data and is acceptable, and below which the data read from the field is considered not to match the model data and is unacceptable). It will be appreciated that a threshold can separate acceptable confidence values from unacceptable confidence values on either side of the threshold. Accordingly, in some embodiments the threshold is exceeded (and is acceptable) when the confidence value of the data read from the field is above a threshold confidence value, while in other embodiments the threshold is exceeded (and is acceptable) when the confidence value of the data read from the field falls below a threshold confidence value. Particularly because confidence values can take a number of different forms as described above, any “range” of confidence values as described herein and in the appended claims does not by itself indicate or imply that high, low, or other confidence values are acceptable or unacceptable. Similarly, the term “threshold” as used herein and in the appended claims does not by itself indicate or imply the location of acceptable and unacceptable ranges with respect to the threshold—only that the threshold separates a range of acceptable confidence values from a range of unacceptable confidence values (or separates a range of acceptable low-confidence values from other ranges of confidence values as will be described in greater detail below). Accordingly, terms such as “exceed”, “above”, “below” used with respect to a confidence value threshold only indicate that the confidence value referred to is on one side of the confidence value threshold (not necessarily which side).

By way of example only, some embodiments of the present invention employ confidence values, thresholds, and ranges in percentage format. That is, the system 50 can establish certain validity thresholds or ranges (e.g., a confidence value of 95% or higher equates to a valid instrument or data record, and a confidence value below 95% equates to an invalid instrument or data record) against which confidence values of data records can be compared. In other embodiments, confidence values can be rated by a scale (e.g., a scale of 1 to 100, such as 1 being the least valid or the least certain of validity, and 100 being the most valid or the most certain of validity), and can compare the certain validity thresholds or ranges to the confidence value of the instrument to determine validity. In some embodiments, the system 50 can be accustomed to identify valid instruments (perhaps based on the confidence value of the instrument), suspect instruments (e.g., instruments whose confidence values can be considered valid, but fall relatively close to the threshold, also referred to as “low confidence”), and invalid instruments.

Although a confidence value can reflect the degree of similarity or difference between data read from a field of a financial instrument and model data, in some embodiments the confidence value of data read from a field of a financial instrument instead or also indicates only that the data read from the field matches model data accessible by the system 50.

With reference again to FIG. 1, the system 50 can include a variety of components for performing and executing one or more validation processes. In some embodiments, the components can be arranged into a local area network (“LAN”), such as, for example, the LAN of a branch in a financial institution (e.g., a bank). In some embodiments, the components can be arranged into a wide area network (“WAN”), such as, for example, the various branch LANs (one branch being remote from another branch) of the financial institution connected across a geographic area. It should be understood that the embodiment illustrated in FIG. 1 is an exemplary embodiment, and that the invention can be carried out through a single component or a combination of different components. For example, any one or more of the hardware components shown in FIG. 1 can be combined or substituted by suitable processing components, as is known in the art.

The system 50 can include one or more servers 55 for executing at least some of the validation processes described herein, and can run any number of applications (as also described herein) to do so. As shown in FIG. 1 by way of example only, the illustrated system 50 include two servers 55. The servers 55 can manage one or more databases, can store files, can provide connections to one or more networks and/or can execute one or more software programs and other applications, and the like. However, in other embodiments, any one or more of these functions can be performed by other components (e.g., one or more of the work stations 70, described below). As another example, the system 50 can instead include a single work station performing all of the functions of the servers 55 and work stations 70 described herein.

In some embodiments (such as that illustrated in FIG. 1), the servers 55 include a first database server 60 and a second file server 65. Although the first database server 60 and the second file server 65 can both perform similar validation processing functions, in some embodiments the first database server 60 controls the transfer of data between components of the system 50, while the file server 65 stores and executes various applications, programs, and services for validating financial instruments as described herein. In other embodiments, the system 50 can include more or fewer servers, any of which can perform and/or execute other suitable functions and programs. The system 50 can also include one or more databases (e.g., database 68 in FIG. 1) to store data such as data representative of signatures, account numbers, names, check images, and other information used to verify the authenticity of an instrument relating to a financial transaction. The database 68 can be accessed via one or more of the servers 55.

The system 50 can also include one or more work stations 70. In some embodiments, the work station(s) 70 include personal computers (“PCs”). In other embodiments, the work station(s) 70 include personal digital assistants (“PDAs”), one or more servers, one or more processing units, and the like. The work stations 70 can run and execute various software programs and other applications and services that perform the configuration, monitoring, and management functions of the system 50 described herein. Like the other connections between the components of the system 50 illustrated in FIG. 1, the work stations 70 can be directly or indirectly connected to the other parts of the system 50 via cable, fiber-optic lines, telephone lines, a wireless network or other wireless equipment, and the like, and can be located in any geographic location with respect to the other components of the system 50.

In some embodiments, the work stations 70 function as user interfaces for one or more users (who can be customers of an entity owning or leasing the system 50, individuals at a entity owning or leasing the system, individuals responsible for maintenance and operation of the system 50 or part of the system 50, or any other party needing access to the system 50). For example, one or more work stations 70 can enable a user to perform a number of tasks associated with instrument validation including, but not limited to, observing and managing one or more of the applications and services that occur within the workflow of the system 50, defining and assigning values to system parameters (e.g., the type of instruments to be validated by the system 50, the data employed by the system 50 in its validation process, and the like), commencing, interrupting, suspending, and terminating the validation process and the supporting applications and services, retrieving and displaying data related to one or more financial instruments (e.g., the status of validation of the financial instrument, model data associated with the financial instrument, one or more images of the financial instrument, data contained within the financial instrument, and the like), and various other tasks. In some embodiments, the work stations 70 provide processing capabilities for applications and services which do not necessitate user interaction, including but not limited to importing and/or formatting of financial instruments (e.g., modifying imported financial instruments into a format useable by the system 50, such as, for example, decoding encoded data or financial instruments, optically recognizing characters printed on financial instruments, and the like), extracting and processing data from the financial instruments (e.g., parsing a financial instrument and “reading” data contained with the financial instrument, initially comparing the data read from the financial instrument to model data accessible by the system 50, and the like), and various other applications and services.

In some embodiments, the system 50 includes one or more work stations 70 having one or more memories for storing data (such as data representative of signatures, account numbers, names, financial instrument images, and other information used in the financial instrument verification process. In these embodiments, the data stored in the database 68 can be alternatively stored in the memories of one or more of the work stations 70. If desired, the memories can also store the various applications and services for execution during the financial instrument validation process (discussed below). In these instances, the work stations 70 can process the data for validating financial instruments in addition to or in substitution for the servers 50 and 55.

In the following description, specific work stations 70 are described to implement specific applications and services of the present invention. As indicated above, however, these applications and services are not limited to the specific work stations illustrated and described herein, but can be implemented on a single component (e.g., a workstation, a server, a processor, another component illustrated in FIG. 1, and the like) or a combination of components (e.g., one or more work stations, one or more servers, one or more processors, one or more of the components illustrated in FIG. 1, a combination of the components thereof, and the like).

In some embodiments, such as the embodiment shown in FIG. 1, the system 50 can include a first work station 80 for managing and monitoring the system 50. In some embodiments, the first work station 80 can control the import, export, type, and/or format of data in the system 50. The first work station 80 can also be employed to observe and manage one or more of the services and applications that occur within the workflow of the system 50, and/or can control access to the system 50 by the other work stations 70. The first work station 80 can execute one or more monitoring and managing applications, such as, for example, a management application, a setup application and/or a monitoring application, as will be discussed below.

The system 50 can also include a second workstation 85 as an interface for importing data into the system 50, such as, for example, data relevant to financial instruments to be validated (e.g., updated transaction information, such as, checks, deposits, withdrawals, account information, client/customer data, and the like) and images of financial instruments—any of which can be employed as model data (i.e., data against which the financial instruments are to be compared). The workstation 85 can import data from various sources internal to the system 50 (such as, for example, another work station 70, the database 68, and the like) or external to the system 50 (such as, for example, an external work station, a memory bank, or a database from a remote system 88). Data can be received by the second work station 85 in a number of different manners, such as in batch form, real-time, and the like, and can be received via any telecommunications medium or combinations of such mediums. In some embodiments, the work station 85 can also execute an import application for importing financial instruments, portions of financial instruments, and/or data from such financial instruments to be compared to the model data as will be described in greater detail below.

The system 50 can also include a third workstation 90 as an interface for importing financial instruments, portions of financial instruments, and/or data from such financial instruments into the system 50. This work station 90 can be similar to the second work station 85. In some embodiments, the third workstation 90 can execute an import application to bring financial instruments, portions of financial instruments, and/or data from such financial instruments, as well as process this matter to make the imported data compatible with the system 50 (e.g., parsing financial instrument data fields, decoding encoded data or financial instruments, optically recognizing characters printed on a financial instrument, and the like). In some embodiments, the third workstation 90 can receive a financial instrument and/or financial instrument data from a component of the system 50 or connected to the system 50, such as, for example, a scanner (shown in FIG. 1 as scanner 95), a bar code reader, a radio frequency identification (“RFID”) reader, a magnetic ink character recognition (“MICR”) reader, a magnetic card reader, an optical character recognition (“OCR”) reader, or any other device employed to read and/or retrieve data from a financial instrument.

The system 50 can also include one or more work stations 70 (e.g., fourth workstation 100, fifth workstation 105, sixth workstation 110, and seventh workstation 115) executing an interrogation application for interrogating financial instruments. In some embodiments, the interrogation of a financial instrument refers to the comparison of data taken from one or more fields of the financial instrument to model data (data that is known to be a standard or known to be valid). This interrogation of a financial instrument is used to validate the financial instrument. Interrogation can be implemented in various manners depending on, for example, the type of financial instrument to be validated, the type of data on the financial instrument or associated with the financial instrument, the model data used in the comparison, and the like. Interrogation can be implemented automatically by a work station, manually by a user via a work station, or semi-automatically by a work station (i.e., processed by the system but manually verified by a user).

For example, a check can be validated using a first method, which can include decoding a security field (including model data) on the face of a check and comparing the decoded information with the information on the face of the check as “read” by a work station 70. Alternatively, the check can be validated using a second method, which can include optically recognizing or reading characters or graphics on the check (such as a signature) and comparing the characters or graphics to a digital signature (i.e., the model data) stored in the database 68 or other memory of or accessible by the system 50. As yet another example, the check can be validated using a third method, which can include displaying an image of the check on a monitor of a work station 70 to enable a user to manually compare the image of the check to model data also displayed on the monitor or on another display. Still other manners of validating such a check are possible and fall within the spirit and scope of the present invention.

The system 50 can also include one or more work stations 120 by which the interrogation application (described below) can be manually operated to any desired degree. In some embodiments, any one or more of the work station(s) 70 can provide access to an user to review and assess suspect financial instruments, to monitor financial instrument processing, and to control the disposition of financial instruments being validated in the system. In some embodiments, any one or more of the work stations 70 can also or instead execute the interrogation process to validate financial instruments, but can request manual verification from a user (e.g., the work station 70 automatically interrogates the financial instrument, generates a confidence level and/or other outcome of the interrogation process, and requests the user to approve or disapprove of the outcome).

As mentioned previously, the system 50 can also include various modules, various applications and/or various services (hereinafter “applications”) that can be executed on one or more of the servers 55 and/or work stations 70. Some applications and some services provide a user interface for one or more users, such as, for example, a setup application and a manual interrogation application (described in greater detail below). These applications allow users to manipulate the system 50 and other applications and/or to monitor and supervise the activities and events taking place within the system 50 (e.g., the processing of financial instruments by the applications). Other applications can be automatically executed without a user interface, such as, for example, some embodiments of the importing application and the interrogation application (described below).

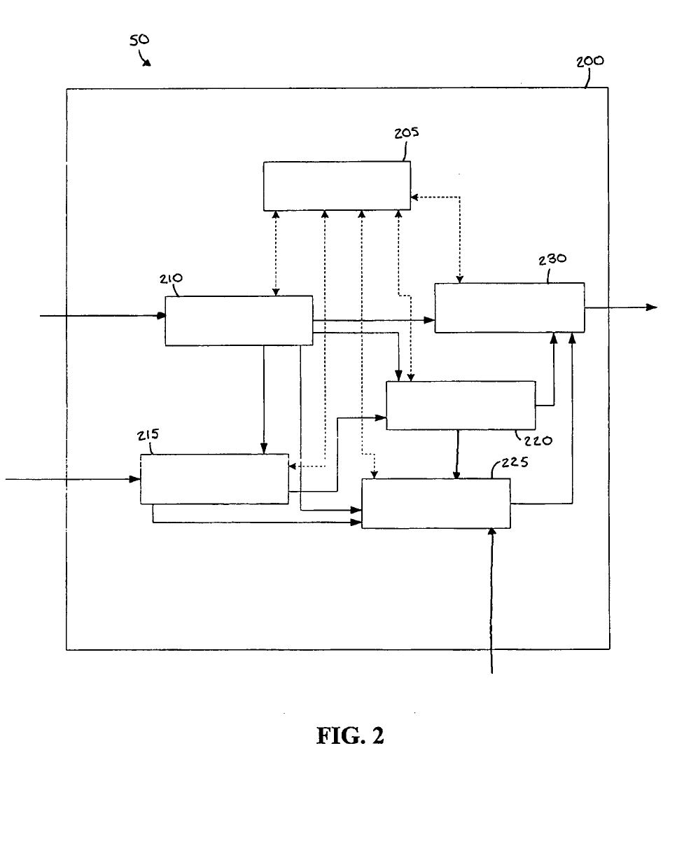

As shown in FIG. 2, the various applications of the system 50 can be executed in an operating environment 200. The operating environment 200 can be independent of specific structure or hardware in the components of the system 50. That is, the operating environment 200 can be implemented using any combination of components and structures. In some embodiments, for example, the operating environment 200 can include any number of components or combination of components illustrated in FIG. 1 and described above. In other embodiments, the operating environment 200 can include a single component (such as a PC, a server, and the like).

In some embodiments of the present invention, the system 50 includes an application that allows a user to support, control and/or supervise financial instrument processing and the workflow of instruments through the system 50. This management application 205 can function as an administrative tool allowing users to view the various applications of the validation system 50 and the operation of the applications, and therefore can perform the function of a monitoring application. The management application 205 can also or instead function as an administrative tool allowing users to maintain the various applications of the validation system 50 (including, for example, the various applications described herein). In addition or alternatively, the management application 205 can function as an administrative tool to facilitate user maintenance of the system 50 (e.g., establishing, maintaining and verifying component connections, distributing or allocating applications and services to system components, maintenance of memory banks, servers, work stations, and databases, and the like ), user maintenance of account information (e.g., establishing and modifying the level of security and access for users of the system 50), and reports (e.g., controlling how reports are generated by the system, the format and contents of such reports, the frequency at which such reports are generated, and the like). The management application 205 can also provide a single interface to the additional applications included in the system 50 (e.g., providing a summary of the status of one or more other applications, granting full access to other applications, and the like).

In some embodiments, the system 50 can include an application that defines and/or determines how financial instruments are processed in the system. This setup application 210 can define the parameters or settings followed by the system 50 during the validation process (e.g., which financial instruments are to be validated, when financial instruments are to be validated, what fields of the financial instrument are to be validated, which model data is to be used during various validation processes, and the like), can be used to view and define confidence level thresholds to be employed in the validation process (e.g., maximum or minimum confidence level values corresponding to fields in the financial instruments), can be used to view and configure the manner in which financial instruments are interrogated (e.g., the order in which data from fields of the financial instrument are processed, what tasks are executed in the event a financial instrument or data from the financial instrument is unacceptable or has a low confidence value, and the like), and can be used to configure various validation methods (e.g., to assign certain validation methods for certain instruments or under certain conditions, and the like).

The setup application 210 can define the settings followed by the system 50 in processing financial instruments, and can also define what makes a financial instrument valid. For example, the settings of the setup application 210 can be configured so that the interrogation application (described below) will interrogate checks under a certain amount (e.g., ten thousand dollars) by comparing and validating the data in two fields of the financial instrument, such as the data in a signature field and an transaction amount field. Continuing with this same example, the settings of the setup application 210 can also be configured so that the interrogation application will interrogate checks over a certain amount (e.g., ten thousand dollars) by comparing and validating the data in three fields of the financial instrument, such as the data in the signature field, the transaction amount field, and a payee field, and will decode data contained in one or more security fields, as described in greater detail below. In another example, the setup application 210 can define priorities or weights to be given to the various data fields of the financial instruments to determine whether the financial instrument will be validated. In yet another example, in some embodiments a user can determine which fields of a financial instrument are to be interrogated first by assigning a higher priority to those data fields. Still other manners of controlling interrogation of financial instruments via the setup application 210 are possible and fall within the spirit and scope of the present invention.

In some embodiments, the manner in which financial instruments are interrogated in the system 50 can change during the interrogation process (described in greater detail below). The setup application 210 in such cases can be employed to define such changes. By way of example only, in some embodiments the interrogation application (described below) responds to a value from a field of a financial instrument by executing one or more resulting commands, any of which can alter settings of the setup application 210. For example, a range of values in the transaction amount field of a financial instrument (e.g., any value over $10,000) can trigger a resulting command to change the manner in which later financial instruments are processed. As another example, a particular bank account number in the account number field of a financial instrument can trigger a resulting command to change the manner in which later financial instruments are processed based upon the validation history of financial instruments of that account (e.g., settings of the setup application 210 can be configured to automatically change based on the account's previous activity, such as a certain number of suspect financial instruments determined over a certain time period).

In some embodiments, the settings of the setup application 210 enable a user to control the manner in which the system 50 processes financial instruments at a number of different levels. For example, in some settings of the setup application, all financial instruments are validated using the same criteria (e.g., same settings, same confidence value thresholds, and the like) and trigger the same or similar responses as a result of the interrogation process. The setup application 210 can allow users to establish different threshold confidence values and/or to define different resulting commands followed by the system 50 as a result of the interrogation process. In a first example, a user can establish a first set of threshold confidence values and/or a first set of resulting commands when validating checks issued to a first payee name. The user can also can establish a second set of threshold confidence values and/or a second set of resulting commands when validating checks issued to a second payee name. Each set of threshold confidence values and resulting commands can be configured globally (e.g., impacting how all checks issued to the first or second payee name are processed in the example above), or can be further defined by one or more other settings of the setup application 210.

As another example, in the case of a party having first and second checking accounts (one for business-related expenses on the order of thousands of dollars, and the other for business-related expenses on the order of hundreds of thousands of dollars), the user can configure the setup application 210 so that checks issued from the second checking account will have one or more relatively high threshold confidence values for one or more of the fields of the checks issued from that account (e.g., the confidence value for the data in the payee name field must be at least equal to a threshold confidence value in order to be considered valid by the system 50), and can trigger any number of resulting commands from the interrogation process (e.g., a set value in a field of the check can trigger an increase in all, some, or one of the validity thresholds for the fields of the same check of other check issued from the same account), while establishing low threshold confidence values and different resulting commands for checks issued from the first checking account.

In some embodiments, the system 50 can also include an application that loads or imports financial instrument data (i.e., financial instruments, portions of financial instruments, or data extracted from financial instruments) into the system 50 in any form, such as graphical images, text data, or data in any other form. This import application 215 can import financial instrument data from any data source, including a remote data source or remote data storage (e.g., for example, a remote database, storage device, a scanner, and the like). In other embodiments, the import application 215 imports or retrieves data from a source or storage included in the system 50, such as, for example, the servers 55, the database 68, and the like. In some embodiments, the import application 215 can also reformat different types of data for entry into the system 50 as needed. Also in some embodiments, the system 50 can include multiple import applications 215, each importing different types of financial instrument data from different types of financial instruments.

The import application 215 can receive financial instruments, portions of financial instruments, and data extracted from financial instruments in any manner, such as by batch files of scanned financial instruments received in a particular electronic format. In some embodiments, the import application 215 can extract headers from the batch data, separate the various financial instruments (or portions thereof, or data extracted therefrom), link the portions of each financial instrument together (in the case of instruments received in parts, such as images and text files relating to the same financial instrument), reformat financial instrument data into a format that is recognized and used by the applications of the system 50, and/or save the various financial instruments (or portions thereof, or data extracted therefrom) in designated areas of the system 50 (e.g., the database 68, a memory of a workstation 70, or another location).

In some embodiments, the import application 215 (or another import application) can retrieve or otherwise receive known and valid data (i.e., model data) for use in the financial instrument validation process. The model data retrieved or otherwise received by the system 50 can be any type of data relating to any portion of the financial instrument, such as a transaction amount, an account number, payor name, payor address (e.g., city, state, or zip code), payee name, financial institution name, financial institution address, signature or endorsement (for example, in digital form), check number, routing number, transaction date, and/or any other information related to the financial transaction. In some cases, the model data can be a copy of the financial instrument itself or portion of the financial instrument (such as when the financial instrument is in electronic form or is available to the system 50 in scanned or other copied form). For example, the model data can be encoded in a seal, watermark, barcode, and the like, included on the financial instrument or a copy thereof. In some cases, this model data can be machine-readable for access by the system 50. The model data can also or instead be included in a file generated concurrently or subsequently to the generation of the actual financial instrument. For example, when a company generates a payroll check, the company may also generate a file which contains some or all of the information printed or encoded on the face of the check. This file can be sent to the system 50 that will validate the check when the check is cashed or processed. Also, model data can be received by the system 50 in batch form, by manual entry through any work station 70, by a live data feed of such model data, and the like. As will be described in greater detail below, this model data is compared to the data from fields of the financial instrument to determine whether the financial instrument is valid.

In some embodiments, the import application 215 can also match financial instruments (or portions thereof, or data extracted therefrom) to the corresponding model data. The import application 215 can extract data contained in one or more fields of the financial instrument, and can compare that data to corresponding model data. For example, the import application 215 can extract the account number and check number from the account and check number fields of a check, and can compare the model account number and model check number in the model data to determine if the financial instrument and model data match. Upon determining that the financial instrument and model data match, interrogation of the financial instrument can take place as described below.

Some embodiments of the present invention employ an application for comparing instrument data with corresponding model data to determine validity. This interrogation application 220 can determine confidence values between data from the financial instruments and corresponding model data as will be described in greater detail below. The confidence values can reflect the degree of similarity or difference between the compared data. In some embodiments, the confidence values given to the data from the financial instruments can be a number, a symbol, or any other indicator or indicia at least reflecting a degree of similarity or difference as just described.

When the interrogation application 220 determines a confidence value between the data from the financial instrument and the model data, the interrogation application 220 compares the confidence value to one or more threshold confidence values (defining the validity of data in the financial instrument) as defined in the setup application 210. For example, if the confidence value(s) of data from one or more fields of the financial instrument is above corresponding threshold confidence values, then the interrogation application 220 determines that the data from the financial instrument is valid. In some embodiments, the confidence value of data from the financial instrument barely surpasses the corresponding threshold confidence value for that data, and therefore can be considered valid, but suspect or having a low confidence (i.e., acceptable but considered questionable). As will be described in greater detail below, financial instrument data determined to be suspect or of low confidence can trigger one or more resulting commands that change the manner in which other fields in the financial instrument or in other financial instruments are processed (e.g., to change other threshold confidence values in the same or other financial instruments) as defined in the setup application 210.

With reference to a check validation process by way of example only, a check (i.e., a financial instrument) that has been presented for payment can be scanned or can otherwise have information retrieved from the check. The data received or retrieved from this check can include the payor's signature, the endorsement (either being in graphical or other suitable form), the account number, the routing number, the check number, the payor's name, the issue date of the check, the check amount, or other information. To validate this check, any one or more of these instrument data items can be compared to corresponding model data on the system 50 or accessible by the system 50, such as a payor's or endorser's signature electronically stored in any suitable form in the database 68, in the server(s) 55, on the check itself, or in another location, and/or a known account number, routing number, check number, payor name, issue date, or check amount stored in any such location. Upon retrieving or otherwise receiving this model data, the model data can be compared to the data received or otherwise retrieved from the check in order to verify that the information on the check is correct.

The validation process described above can include any number of comparisons made between data from fields of the financial instrument and corresponding model data. In some embodiments, a number of comparisons are made between data in fields of the financial instrument and corresponding model data, such comparisons potentially including multiple dependent and independent interrogation processes or methods running in parallel. A workflow, as determined by the management application 205 and the setup application 210, can define and control the flow of the instruments being validated through these processes based on preset or dynamic rules. The ability to employ two or more independently-controllable and adjustable comparisons between a financial instrument and corresponding model data (using data from different fields of the financial instrument and model data corresponding to such fields) in the same interrogation application 220 provides significant power to the system 50.

In some embodiments, the system 50 can also include an application that allows one or more users to manually match and/or validate financial instruments. This manual interrogation application 225 can be a substitute for the interrogation application 220 described above, or can be employed in addition to or in support of the interrogation application 220 described above. In some embodiments, the manual interrogation application 225 can enable a user to validate financial instruments (as defined in the setup application 210) in a manner similar to the various methods described above with reference to the interrogation application 220. For example, the manual interrogation application 225 can be employed to interrogate a financial instrument and to compare data from fields of the financial instrument to model data in a manner similar to that described above with reference to the interrogation application 220, but with manual verification from a user. In other embodiments, manual verification includes displaying an image of the financial instrument (or portion thereof, or data extracted therefrom) on a display (e.g., a window or other graphical user interface on a monitor or screen), displaying the model data in the same or different graphical user interface, having a user manually compare the information presented, and accepting or rejecting the financial instrument.

In some embodiments, the system 50 can also include an application that outputs the results of whether financial instruments are valid or invalid. This export application 230 can export the financial instrument or information corresponding to the financial instrument along with an indication regarding whether or not the financial instrument is valid. This information can be provided on a display at any of the work stations 70, can be printed, or can be provided to a user in any other suitable manner. The export application 230 can also generate various reports citing fraudulent or invalid items, valid items, items requiring addition verification, and the like.

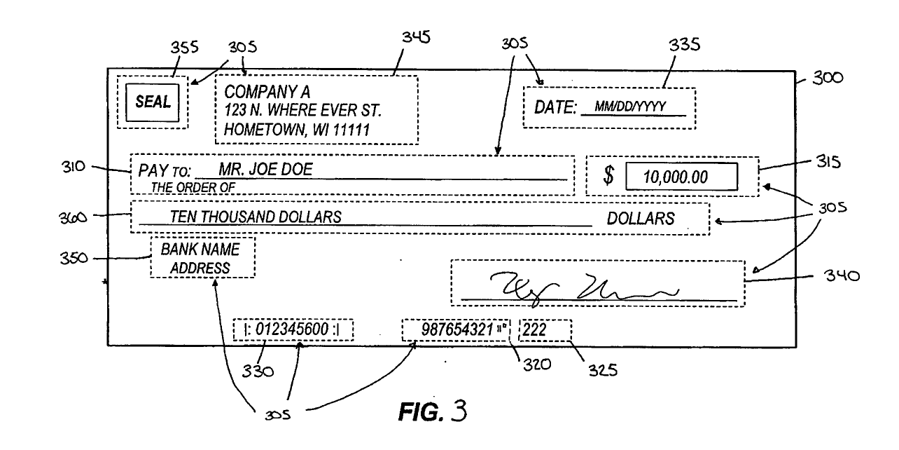

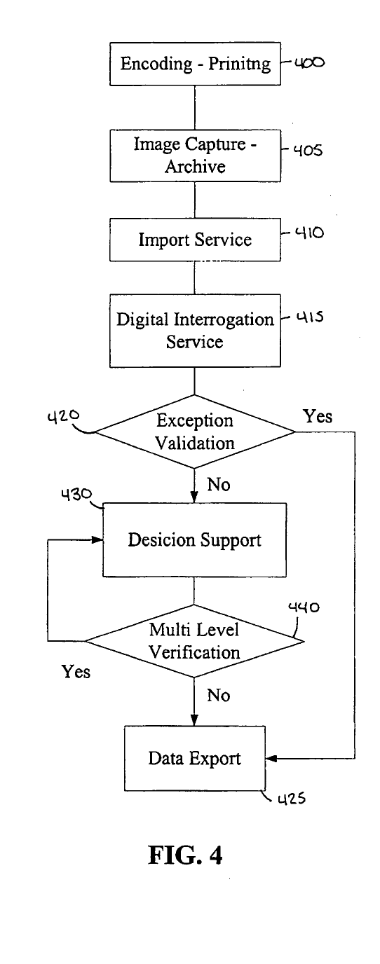

An exemplary implementation of the present invention is provided in FIGS. 3 and 4, and is described below. In this implementation, the system 50 is employed to validate a payroll check. This check 300 is an example of a financial instrument, and includes a series of fields 305 containing data that defines the transaction. As shown in FIG. 3, the check 300 can include a payee field 310, an amount field 315, an account field 320, a check number field 325, a routing field 330, a date field 335, and a signature field 340, and can also include an endorsement field (not shown). Also shown in FIG. 2, the check 300 can include a payor field 345, a financial institution field 350, a security field 355, and a character amount field 360. In some alternate embodiments, the payor field 345 and/or the financial institution field 350 are defined by multiple fields, such as separate fields for the financial institution name, city, state, and zip code and/or for the payor name, city, state, and zip code.

With reference now to FIG. 4, a bank or other financial institution issues a check (at 400). In some embodiments, the bank or other financial institution that issues the check 300 can also create a file (referred to as an “issue file”) containing the model data for the check 300. This issue file can include all or some of the data printed on the face of the check 300, such as, for example, payee data (e.g., data included in the payee field 310 of the check 300), bank data (e.g., data included in the payee field 310 of the check 300), and the like. This issue file can also include other data useful for the validation process. In other embodiments, the bank or other financial institution that issues the check 300 can include the model data (and other data, as desired) on the check 300 itself. For example, the model data can be encoded and positioned within the security field 355 of the check 300 in various forms, such as, a seal, a bar code, background image, a watermark, and the like. In this embodiment, the bank may not need to create a separate file (e.g., a copy of the check, an issue file, and the like).

In some cases, the check 300 is printed when all information necessary to complete the check 300 is included on the check 300. However, in other cases, the check 300 is a blank check 300, and can be completed by a party at a later time.

After the check 300 is presented for payment, the check 300 can be scanned into the system 50 by a scanner 95, thereby creating an image of the paper check 300 (referred to hereinafter as “the image 300”) (at 405). The import application 215 of the system 50 can capture the image of the check 300, and can obtain the model data from either the issue file or the security field 355. The import application 215 can retrieve or otherwise receive corresponding model data and can store some or all of the corresponding model data in the database server 60 (at 410), if desired. In some embodiments, the import application 215 can also extract header information from the image 300, associate the image 300 with related model data, and update workflow-related information, such as, for example, the state and the location of the check image, and the like. When the image 300 is matched with a corresponding issue file containing the corresponding model data for the check 300, the image 300 can then be stored in a queue awaiting interrogation.

The interrogation application 220 or 225 can retrieve the image 300 (either alone or in a group of other images 300) based upon the state and priority of the image (i.e., first in, first out, in some embodiments). The interrogation application 220 can then perform a series of interrogations on the image 300 to determine the value of the specified fields 305 (at 415). In some embodiments, the values in the specified fields 305 can be numbers, words, combinations of numbers and words, graphical images, and the like. Obtaining data from the fields can be performed in any conventional manner (e.g., via an OCR reader, a MICR reader, and the like). The interrogation application 220 can then compare these values of the image 300 to the corresponding model data to produce a confidence value for each field. The confidence values correlate to the similarities between “recognized data” (i.e., data interpreted by the import and interrogation applications 215, 220) to the model data (i.e., the validation data included in the security field 355 of the image 300, the issue file, and the like).

The interrogation application 220 also can compare the confidence value for a particular field to a corresponding threshold confidence value to determine if the data in the field (and possibly the image 300) is in error or is fraudulent (at 420). In some embodiments, if the confidence value resulting from a comparison of data in a field to its corresponding model data is greater than a threshold confidence value for that field, then the data in that field is considered valid. It will be appreciated that in some embodiments, data in a field will be considered valid only if the confidence value for that data meets or exceeds a threshold confidence value.

A determination of whether an instrument is valid can be based upon any number of confidence values generated by the interrogation application 220. In some embodiments, a comparison is made by the interrogation application 220 between data in a single field of an instrument and its corresponding model data. In other embodiments, comparisons are made by the interrogation application 220 between data in two or more fields of an instrument and their corresponding model data, each comparison generating a confidence value. In some embodiments, a user can define the type of fields to be interrogated, the type of data to be validated, and/or the manner in which the data is validated by the interrogation application 220 through the setup application 210. For example, in some embodiments a user can access the setup application 210 via a workstation 70, and can view one or more user interfaces that enable the user to select from a number of possible types of data fields of a financial instrument. In the case of processing checks in financial transactions for example, such as the check 300 (or check image 300) illustrated in FIG. 3, the user can select a payor field 305, payee field 310, financial institution name field 350, account number field 320, routing number field 330, check number field 325, check date field 335, amount field 315, signature field 340, endorser field (not shown), and/or one or more address fields (e.g., state, city, or zip code fields of the payor or financial institution), in some embodiments. By selecting these fields (such as the fields 305 of the check 300 in FIG. 3) in the setup application 210, the user requests that the interrogation application 220 compare the values in these fields of financial instruments with model data accessible to the interrogation application 220. It will be appreciated that any number and combination of these fields can be selected in various embodiments, and in some cases can be freely changed by the user as desired (in preparation for processing a batch or financial instruments at any given time).

Once the field selection settings of the setup application 210 are set as just described, a user can access the same or a different user interface to save the settings and/or to command the interrogation application 210 to begin (or continue) processing financial instruments using the settings.

When two or more comparisons are made using data from two or more different fields in an instrument, a decision regarding the validity of the instrument can be made by the interrogation application 220 in a number of different manners. In some embodiments, if any one confidence value falls outside of a range of acceptable confidence values (e.g., falls below a threshold confidence value), the interrogation application 220 automatically concludes that the instrument is invalid, or concludes that additional verification, such as via the manual interrogation application 225, is needed. In other embodiments, any number of additional confidence values must fall outside of respective acceptable ranges before such a conclusion will be made by the interrogation application 220. In some embodiments, the number of confidence values that must fall outside of acceptable ranges can be set by a user via a user interface, such as a user interface of the setup application 210 described above. For example, the setup application 210 can be configured by a user to compare the values of six fields in a financial instrument with model data corresponding to each field, and so that the interrogation application 220 will determine that the financial instrument is invalid only if the values of at least two of the fields fall outside of their respective acceptable confidence value ranges.

In some embodiments, a user can change the manner in which the interrogation application 220 determines whether an instrument is valid based upon the comparison of the values of one or more fields to corresponding data regarding the financial transaction. This setup or adjustment can take place via a user interface of the setup application 210 or another application, wherein a user can input the acceptable ranges of one or more confidence values corresponding to comparisons made by the interrogation application 220 as described above. For example, the setup application 210 can enable a user to select or input a threshold confidence value corresponding to each field of a financial instrument to be processed (e.g., enter a 95% confidence level for the value in the signature field 340 of the financial instrument 300 as the signature field validation threshold, a 80% confidence level for the value in the date field 335 of the financial instrument 300 as the date field validation threshold, and the like). In this example, if the values in the signature and date fields 340 and 355, respectfully, of the financial instrument 300 generate confidence values of 97% and 90%, respectively, the interrogation application 220 can automatically determine that the financial instrument 300 is valid. However, in this same example, if the generated confidence values are 93% and 85%, respectively, the interrogation application 220 can automatically determine that the financial instrument 300 is not valid (in which case the signature on the financial instrument 300 may not be sufficiently similar to the model signature to which it is compared, although the date on the financial instrument 300 may be blurred), or needs manual validation.

In many applications, the importance of the data in each field of the instrument is not identical. For example, the data in the signature field 340 of the check 300 can be significantly more important than the date field 335 of the same check 300. Accordingly, some embodiments of the present invention give different weight to the data in the different fields of the instrument processed by the interrogation application 220. In such cases, the decision regarding the validity of the instrument can be made by weighing the data in each field as desired, and generating an overall confidence value of the instrument. This overall confidence value can be compared by the interrogation application 220 to a range of acceptable confidence values (e.g., to an overall threshold confidence value) to determine whether the financial instrument is valid. In some embodiments, the user can modify the importance or weight of a data field in the setup application 210. Such modifications can be made, for example, via the setup application 210 accessible by a user at a work station 70. Using one or more user interfaces of the setup application 210, the user can enter or select the weight placed on the confidence values of each field (e.g., by selecting from a range of integers from 1-10, a range of percentages from 0-100%, or in any other scale), and can then save the resulting configuration for use in processing instruments as desired.

In some embodiments of the present invention, the manner in which instruments are processed can be automatically changed by the interrogation system 220. A number of events can trigger such a change. In some embodiments, the confidence levels assigned to the fields of a financial instrument can be changed based upon the calculated confidence levels of one or more values in the fields or in the fields of another financial instrument processed by the system 50. For example, upon calculating the confidence level of a value in a field of a financial instrument, the interrogation application 220 can modify the threshold confidence levels for one or more other fields in the same instrument (e.g., based upon a relatively low confidence level of the value in a signature line of a financial instrument, the interrogation application 220 can automatically increase the threshold confidence levels of one or more other fields in the financial instrument). This capability enables the interrogation application 220 to automatically adapt when confidence levels of one or more values in a financial instrument are low (e.g., the data may be suspect), but do not pass a confidence level threshold that would otherwise trigger an exception for the financial instrument. It will be appreciated that in some cases, the confidence levels of one or more (and in some cases, all or almost all) values in a financial instrument may be relatively low, but sufficiently high to pass the threshold confidence level for each field. As an alternative to automatically permitting the financial instrument to pass in such cases, the interrogation application 220 in some embodiments can automatically raise the threshold confidence levels of one or more fields when a relatively low (but passing) confidence level is calculated for the value in another field.

In some embodiments, one or more fields of a financial instrument are assigned a range of confidence values that include a sub-range of unacceptable confidence values and a sub-range of acceptable confidence values separated by a threshold. In other embodiments, one or more fields of a financial instrument are assigned a range of confidence values that include first, second, and third sub-ranges separated by a low-confidence threshold between the first and second sub-ranges and by a threshold between the second and third sub-ranges. If the confidence value of data in a field of the financial instrument falls within the first sub-range (or another unacceptable confidence value range in other embodiments), the interrogation application 220 will automatically determine that the financial instrument is invalid or fraudulent, and in some embodiments one or more resulting commands are executed to change the manner in which the interrogation application 220 processes values in one or more fields in other financial instruments. If the confidence value of the data instead falls within the second sub-range (defining a range of confidence values that are relatively low, but that still represent acceptable confidence levels), one or more resulting commands can be executed to change the manner in which the interrogation application 220 processes the values in one or more other fields in the financial instrument and/or one or more other fields in other financial instruments. If the confidence value of the data instead falls within the third sub-range (or another acceptable confidence value range in other embodiments) defining a range of acceptable confidence values that are relatively high, the data in the field in automatically considered valid.

As just described, the threshold confidence value of a field in the same or a different financial instrument can be changed by a resulting command if a value of another field in the financial instrument falls within a low or no-confidence range. In many applications, a financial instrument can have several fields that are verified, any of which can fall within such a range, and any of which can have a resulting command that modifies the same field in the same or different financial instrument. Therefore, it is possible that the threshold confidence value of any field can be modified two or more times by different resulting commands. For example, the values in a signature field 340 and an account number field 320 of a financial instrument (e.g., a check 300) can each trigger resulting commands to raise a threshold confidence value of the payor field 305 in the same financial instrument 300. Therefore, if the values in the signature field 340 and account number field 320 each fall within a low-confidence range, the resulting command of the signature field 340 can raise a threshold confidence value of the payor field 305 a first amount, while the resulting command of the account number field 320 can raise the threshold confidence value of the payor field 305 a second amount (i.e., in addition to the first amount). As another example, the values in a signature field 340 and an endorsement field (not shown) of a financial instrument (e.g., a check 300) can each trigger resulting commands to raise a threshold confidence value of the signature field 340 in other financial instruments having the same account number. Therefore, if the values in the signature and endorsement fields each fall within a low-confidence range, the resulting commands of the signature and endorsement fields can each raise a threshold confidence value of signature fields 340 in other financial instruments having the same account number. It will be appreciated that this “cascading” effect of repeatedly modifying confidence levels of financial instrument fields can be repeated as many times as desired.

The ranges of confidence values described above can take a number of different forms, such as a range of numbers, a set of letters, a set of colors, and the like, each element in the range or set reflecting a different confidence value, and therefore reflecting a different degree of similarity or difference between data from a field of the financial instrument and corresponding model data accessible by the interrogation application 220. For example, a signature field in a financial instrument can have a range of confidence values corresponding to the similarity of a signature in the field to a model signature accessible by the interrogation application 220. As another example, an account field in a financial instrument can have a range of confidence values corresponding to the similarity of an account number in the field to a model account number accessible by the interrogation application 220.

As discussed above, in some embodiments one or more resulting commands are executed by the interrogation application 220 (thereby changing the manner in which the interrogation application 220 processes data in one or more other fields in the same or different financial instruments) if a confidence value of data in a field of the financial instrument falls within an unacceptable range and/or a low-confidence range. These resulting commands can therefore be associated with a field of a financial instrument, and in some embodiments are executed by the interrogation application 220 (if such resulting commands are triggered as just described). Any number of resulting commands can be associated with the same field of the financial instrument. Also, any number of fields can have one or more associated resulting commands triggered if a confidence value of data in the field falls within an unacceptable range and/or a low-confidence range.

The resulting commands triggered by an unacceptable and/or low confidence level can alter the manner in which the interrogation application 220 functions in a number of different ways. One type of resulting command changes a threshold confidence level (e.g., either type or both types of confidence level thresholds described above) of one or more fields in the same financial instrument. For example, a confidence level of a signature (e.g., in a financial instrument) falling with a range of low-confidence levels set for the signature field can trigger a resulting command to increase a threshold confidence level of the transaction amount field in the same financial instrument. In other words, if the signature on the financial instrument is suspect (but not necessarily invalid), the interrogation application 220 will hold the data in the transaction amount field of the financial instrument to an heightened standard in order to validate the financial instrument.

Another type of resulting command changes a threshold confidence level of one or more fields in another financial instrument. For example, a confidence level of a payee name (e.g., in a financial instrument) falling within a range of unacceptable confidence levels set for the payee field can trigger a resulting command to increase a threshold confidence level of the account number field in one or more other financial instruments and another resulting command to increase a threshold confidence level of the endorsement field in one or more other financial instruments. In other words, if the value in the signature field on the financial instrument automatically triggers an exception for the financial instrument (e.g., if the signature is a poor match to a model signature accessible by the import application 215), the interrogation application 220 can hold the data in one or more other fields (e.g., the signature fields or transaction amount fields) of other financial instruments to a heightened standard. Yet another type of resulting command changes a threshold confidence level of one or more fields in the same and different financial instruments, essentially performing the same functions as the two resulting commands described above.

As described above, a resulting command executed by the interrogation application 220 (in response to a low or no-confidence determination of a value in a field of a financial instrument being processed) can alter one or more confidence thresholds of one or more fields of other financial instruments. Although not required in some embodiments of the present invention, the other financial instruments can be related in one or more manners to the financial instrument being processed. For example, the other financial instruments can share the same account number, routing number, payee, payor, signature, endorsement, financial institution, payor address (i.e., city, state, and/or zip code), and the like. Therefore, if one or more values in fields of a financial instrument trigger a resulting command processed by the interrogation application 220, the resulting command can be to retain one or more elements of data regarding the financial transaction (e.g., the same account number, routing number, payee, payor, signature, endorsement, financial institution, payor address (i.e., city, state, and/or zip code), and the like) in volatile or non-volatile memory of the system 50 for later reference by the interrogation application 220, along with one or more changes to be made to later-processed financial instruments matching the element(s) of data. For example, a resulting command triggered by a low or no-confidence value of a signature can instruct the interrogation application 220 to record the account number and payor of the financial instrument in the database 68, along with instructions to raise the confidence threshold of the signature field (and/or any other fields). The interrogation application 220 thereafter references the database 68 to determine whether later-processed financial instruments (or user-designated financial instruments) match these account or payor values. If so, the interrogation application 220 follows the instructions to raise the confidence threshold of the signature fields in such financial instruments.

A resulting command can specify one or more criteria that must be met by later-processed financial instruments in order to change such financial instruments. In some embodiments, the resulting command only references one data element (e.g., the same account number, routing number, payee, payor, signature, endorsement, financial institution, payor address (i.e., city, state, and/or zip code), and the like) from the financial transaction that triggered the resulting command. If this single data element is matched by another later-processed financial instrument, then the accompanying instructions to change one or more confidence levels of that financial instrument are executed by the interrogation application 220. For example, a resulting command triggered by the financial instrument can reference the account number of the financial transaction, in which case later financial instruments having the same account number will have one or more modified threshold confidence levels. However, in other embodiments, the resulting command references two or more data elements from the financial transaction that triggered the resulting command. If all of the data elements are matched by another later-processed financial instrument, then the accompanying instructions to change one or more confidence levels of that financial instrument are executed by the interrogation application 220. For example, a resulting command triggered by the financial instrument can reference the account number and signature of the financial transaction, in which case only those later financial instruments having the same account number and signature will have one or more modified threshold confidence levels.

It will be appreciated that the resulting commands executed by the interrogation application 220 can generate a wide range of changes to the manner in which the same and other financial instruments are processed by the system 50. For example, a resulting command can generate a widespread impact upon the manner in which later financial instruments are processed, such as by referencing a bank name or a payor city (in which case any later financial instrument having the same bank name or the same payor city will have one or more heightened confidence thresholds). As another example, a resulting command can generate a surgical or pinpoint impact upon the manner in which later financial instruments are processed, such as by referencing an account number and payee name (in which case any later financial instrument having the same account number with the same payee name will have one or more heightened confidence thresholds), or by being limited to change the threshold confidence values of one or more fields in the same financial instrument. A significant amount of flexibility is provided by such resulting commands, in some embodiments enabling the system 50 to monitor and control financial instrument processing activity at any level: by account number, routing number, check number, payor name, payee name, transaction amount, financial institution, address (e.g., city, state, or zip code of the payor and/or financial institution), signature, endorsement, and any combination thereof.

In some embodiments of the present invention, a user can change, add, delete, enable and/or disable (hereinafter, “modify”) the resulting commands followed by the interrogation application 220. This capability can be limited to any extent desired, such as by enabling a user to change only certain resulting commands while protecting others from being changed (or being changed by certain users). Any user interface can be employed for a user to modify resulting commands. For example, in the illustrated embodiment of FIG. 1, a user can access one or more user interface screens of the system 50 via a workstation 70. Although any application can be employed to enable modification of the resulting commands, the setup application 210 is used for this purpose in the illustrated exemplary embodiment. Upon accessing the setup application 210, the user can navigate to one or more resulting commands in a number of different manners, such as by identifying an account number, payor name, or other data element of a standard financial transaction in one or more search fields of a user interface, by browsing through a file system arranged in order of such fields, and the like.

In some embodiments a resulting command operates only upon the financial instrument that is being processed by the interrogation application 220. For example, the resulting command can be associated with a transaction amount field of a financial instrument, and can instruct the interrogation application to raise the threshold confidence value of the signature field of the same financial instrument.

In some embodiments, a resulting command operates globally to change the manner in which all later-processed financial instruments are processed by the interrogation application 220. For example, the resulting command can be associated with the signature field of a financial instrument, and can instruct the interrogation application to raise the threshold confidence value of all signatures in all later-processed financial instruments.

In other embodiments, a resulting command will employ information from the financial transaction being processed in order to determine the type and scope of changes to make to later-processed financial instruments. For example, the resulting command can employ the account number, payor name, or financial institution name (among other data elements) in order to generate instructions for the interrogation application 220 to follow if and when a later-processed financial instrument matches such data elements as described above. For example, the resulting command can be associated with the signature field and account number of a financial instrument, and can instruct the interrogation application to raise the threshold confidence value of all signatures in all later-processed financial instruments having the same account number.

To modify a resulting command, a user can navigate through one or more user interface screens in the setup application 210 via search or browse controls corresponding to standard fields in financial transactions (e.g., account number, financial institution name, payor name, and the like). In some embodiments, the list of resulting commands matching the standard fields selected and/or the information entered by the user in such standard fields is updated in a live manner or following a search command from the user. The user can select any such resulting command for manually viewing and/or modifying the command as desired. A similar process can be followed to enter a new resulting command.

It is often desirable to control the duration of a resulting command. Although a resulting command can be set until modified by a user, in some embodiments the resulting command includes one or more instructions regarding change(s) of the resulting command and/or its enforcement over time. For example, it may be desirable to relax or eliminate a heightened confidence level threshold of a field after a specified period of days, weeks, or months. As another example, it may instead or also be desirable to relax or eliminate a heightened confidence level threshold of a field after a specified event, such as when a particular type of transaction occurs (e.g., after the system 50 receives information that a threshold low check number has been processed on a particular account), after a specified number of transactions have occurred (e.g., after the system 50 receives or calculates information that a set number of checks have been processed in the same account without triggering any additional resulting commands), after a specified amount of time has passed (e.g., after the system 50 receives or calculates information that an account has been active for a minimum threshold period of time), and the like. When the specified event, number of transactions, time, or other action is triggered, the resulting command can include instructions regarding how to process later financial instruments, such as to reduce the confidence level an amount, to de-activate the resulting command, or to take another action. In some embodiments, one or more resulting commands are automatically provided with modification rules when the resulting commands are created. Also, in some embodiments, a user can access and modify the modification rules of resulting commands in a manner similar to that described above with reference to the modification of resulting commands.

In some embodiments, if the confidence value of data in a field of an instrument is unacceptable (e.g., falls below a threshold confidence value of that field), that field (or the data in that field) and/or that instrument can be flagged by the interrogation application 220. In other embodiments, the field, data, or instrument is flagged only if the instrument is determined by the interrogation system 220 to be invalid. In either case, the resulting flagged matter can be presented to a user by the export application 230. The flag or “exception” indicator can indicate any number of different actions, such as to resubmit the data in the field, to resubmit the instrument or image 300 for interrogation, to submit the instrument or image 300 for manual interrogation by the manual interrogation application 225, to mark the instrument or image 300 as fraudulent, and the like.

In some embodiments, if the instrument or image 300 is marked with an exception error, manual interrogation or decision support can be implemented (at 430 in FIG. 4). In some embodiments, the manual verification process involves verifying the fields and/or images that have raised an exception during the automatic interrogation process by the automatic interrogation application 220. The user can review these images and/or the instruments or instrument data relevant to the exception on a first-in-first-out or other basis, and can determine how each image will be processed in the subsequent workflow. For each such instrument, the user can choose to accept or decline the recognized instrument data or can replace the recognized instrument data with the model data. The instrument can also be routed for another level of verification or can be flagged as an invalid or fraudulent item requiring further inquiry (at 440 in FIG. 4).

After interrogation is completed, the instrument or image 300 can be exported (at 425 in FIG. 4) by the export application program 230. A report or message, such as, for example, a table, document, email, record, and the like, can be generated by the export application 230. In some embodiments, the export application creates an output file, and can route the file to any location.

Various features and advantages of the invention are set forth in the following claims.

1. A method of validating a financial instrument relating to a financial transaction, the method comprising:
obtaining data defining a first part of the financial transaction;
obtaining data defining a second part of the financial transaction;
comparing the data defining the first part of the financial transaction with a value in a first field of the financial instrument to define a first comparison and to generate a first confidence value, the first confidence value at least partially defining a degree of difference between the data defining the first part of the financial transaction and the value in the first field of the financial instrument;
comparing the data defining the second part of the financial transaction with a value in a second field of the financial instrument to define a second comparison and to generate a second confidence value, the second confidence value at least partially defining a degree of difference between the data defining the second part of the financial transaction and the value in the second field of the financial instrument;
providing first and second ranges of acceptable confidence values for the first and second comparisons, respectively;
comparing the first confidence value to the first range of acceptable confidence values, the first range of acceptable confidence values including a range of low confidence values; and
altering the second range of acceptable confidence values if the first confidence value falls within the range of low confidence values.

2. The method as claimed in claim 1, further comprising leaving the second range of acceptable confidence values unchanged if the first confidence value falls within the range of acceptable confidence values but outside of the range of low confidence values.

3. The method as claimed in claim 1, further comprising retrieving the first and second ranges of acceptable confidence values from a memory in which confidence value ranges are stored.

4. The method as claimed in claim 3, further comprising retrieving the data defining the first and second parts of the financial transaction from a memory.

5. The method as claimed in claim 4, further comprising regularly updating the memory with data defining new financial transactions.

6. The method as claimed in claim 1, further comprising retrieving the data defining the first and second parts of the financial transaction from the financial instrument.

7. The method as claimed in claim 6, wherein the data defining the first and second parts of the financial transaction are retrieved from a machine-readable portion of the financial instrument.

8. The method as claimed in claim 1, wherein at least one other range of acceptable confidence values corresponding to the value of another field of the financial instrument is at least partially dependent upon the first confidence value.

9. The method as claimed in claim 8, wherein the at least one other range of acceptable confidence values is also at least partially dependent upon the second confidence value.

10. The method as claimed in claim 1, wherein the financial instrument is a check having a payor field, a payee field, an amount field, and an account number field.

11. The method as claimed in claim 10, wherein the first field is one of the payor field, the payee field, the amount field, the account field, a routing number field, a financial institution name field, a signature field, an endorser field, and a date field.

12. The method as claimed in claim 1, further comprising automatically returning the second range of acceptable confidence values to an original state after a period of time.

13. The method as claimed in claim 1, further comprising automatically returning the second range of acceptable confidence values to an original state after a predetermined number of financial transactions sharing a value of a field in common with a value of a corresponding field in the financial instrument.

14. The method as claimed in claim 13, wherein the value of the field of the predetermined number of financial transactions is an account number.

15. The method as claimed in claim 13, wherein the value of the field of the predetermined number of financial transactions is one of a payor name and a payee name.

16. The method as claimed in claim 1, further comprising matching the financial instrument with data representing at least part of the financial transaction retrieved from a machine-readable memory.

17. The method as claimed in claim 1, further comprising retrieving the data defining the first and second parts of the financial transaction from a memory in which are stored data defining parts of other financial transactions are stored.

18. The method as claimed in claim 1, further comprising:
matching the value in the first field of the financial instrument with the data defining the first part of the financial transaction; and
retrieving the data defining the first part of the financial transaction from a memory in which is stored data defining other parts of the financial transaction.

19. The method as claimed in claim 1, further comprising flagging the financial document if at least one confidence value corresponding to a value in a field of the financial instrument falls within a range of low confidence values but outside of a range of values triggering rejection of the financial instrument.

20. The method as claimed in claim 1, further comprising accessing a processor and a validation application operating thereon via a work station, wherein comparing the data defining the first and second parts of the financial transaction is performed at least in part by the validation application.

21. The method as claimed in claim 20, further comprising manually reviewing data reflecting the first comparison via the work station.

22. The method as claimed in claim 21, further comprising entering at least one command via the work station to one of accept and reject the financial document.

23. The method as claimed in claim 21, further comprising manually reviewing the first and second parts of the financial data and the data defining the first and second parts of the financial transaction via the work station.

24. A method of validating a financial document, comprising:
obtaining a digital representation of the financial document, the financial document having a first data field and a second data field;
obtaining a first data record from the first data field of the financial document;
establishing a first validation threshold corresponding to the first data field;
obtaining a second data record from the second data field of the financial document;
establishing a second validation threshold corresponding to the second data field;
retrieving a first model record corresponding to the first data record;
comparing the first data record to the first model record;
generating a first confidence value corresponding to the comparison of the first data record to the first model record, the first confidence value reflecting a degree of similarity between the first data record and the first model record;
modifying the second validation threshold if the first confidence value is within a predefined range of low confidence values to produce a modified second validation threshold; retrieving a second model record corresponding to the second data record;
comparing the second data record to the second model record;
producing a second confidence value corresponding to the comparison of the second data record to the second model record, the second confidence value reflecting a degree of similarity between the second data record and the second model record; and
comparing the second confidence value to the modified second validation threshold.

25. The method as set forth in claim 24, wherein the modified second validation threshold separates a range of acceptable confidence values corresponding to sufficiently similar data and model records for data record validation from a range of unacceptable confidence values corresponding to insufficiently similar data and model records for data record validation; the method further comprising validating the financial document if the second confidence value falls within the range of acceptable confidence values.

26. The method as set forth in claim 24, wherein the financial document has a third data field, the method further comprising;
obtaining a third data record from the third data field;
establishing a third validation threshold corresponding to the third data field;
modifying the third validation threshold a first amount if the first confidence value is within the predefined range of low confidence values;
modifying the third validation threshold a second amount if the second confidence level is within a second predefined range of low confidence values to produce a modified third validation threshold;
retrieving a third model record corresponding to the third data record;
comparing the third data record to the third model record; producing a third confidence value corresponding to the comparison of the third data record to the third model record, the third confidence value reflecting a degree of similarity between the third data record and the third model record;
validating the document if the third confidence level is approximately greater than or equal to the further modified third validation threshold; and
comparing the third confidence value to the modified third validation threshold.

27. A method of automatically financial instruments, the method comprising:
obtaining a first digital representation of a first financial instrument having a first field;
obtaining a second digital representation of a second financial instrument having a second field, the second field representing substantially the same type of information as the first field;
establishing a first validation threshold for the first field and a second validation threshold for the second field, the second validation threshold being substantially the same as the first validation threshold;
comparing data in the first field to corresponding first model data to produce a first confidence level of the data in the first field;
validating the first financial document and leaving the second financial threshold unchanged if the first confidence level exceeds the first validation threshold;
modifying the second validation threshold if the first confidence level does not exceed the first validation threshold but exceeds a low-confidence validation threshold of the first field to produce a modified second validation threshold, the low-confidence validation threshold of the first field different than the first validation threshold;
comparing data in the second field to corresponding second model data to produce a second confidence level of the data in the second field; and
validating the second document if the second confidence level exceeds the modified second validation threshold.

28. The method as set forth in claim 27, further comprising obtaining a third digital representation of a third financial instrument having a third field, the third field representing substantially the same type of information as the first and second fields;
establishing a third validation threshold for the third field, the third validation threshold being substantially the same as the first validation threshold and the second validation threshold;
modifying the third validation threshold if the first confidence level does not exceed the first validation threshold but exceeds the low-confidence validation threshold of the first field;
further modifying the third validation threshold if the second confidence level does not exceed the modified second validation threshold but exceeds a low-confidence validation threshold of the second field to produce a modified third validation threshold, the low-confidence validation threshold of the second field different than the modified second validation threshold;
comparing data in the third field to corresponding third model data to produce a third confidence level of the data in the third field; and
validating the third document if the third confidence level exceeds the modified third validation threshold.

29. A method of validating a financial instrument having a first data field and a second data field, the method comprising:
establishing criteria triggering a confidence threshold increase for the first data field of the financial instrument, the criteria accessible by a processor adapted to compare data from fields of the financial instrument to the criteria;
obtaining a second data record from the second data field of the financial document;
comparing the second data record to the criteria with the processor; and
automatically modifying the confidence threshold of the first data field of the financial instrument if the criteria are met by the second data.
